(19) United States
(12) Patent Application Publication
(10) Pub. No.: US 2018/0288354 A1
(43) Pub. Date: Oct. 4, 2018

(54) AUGMENTED AND VIRTUAL REALITY PICTURE-IN-PICTURE

(71) Applicant: Intel Corporation, Santa Clara, CA (US)

(72) Inventors: Glen J. Anderson, Beaverton, OR (US); Carl S. Marshall, Portland, OR (US)

(21) Appl. No.: 15/476,119

(22) Filed: Mar. 31, 2017

(51) Int. Cl. H04N 5/45; G06T 11/60; G06F 3/01; H04N 5/44; G02B 27/01; A63F 13/5378

(52) U.S. Cl. CPC H04N 5/45; G06T 11/60; G06F 3/011; A63F 2300/307; G02B 27/0172; A63F 13/5378; G02B 2027/014; H04N 5/4403

(57) ABSTRACT

Various systems and methods for presenting mixed reality presentations are described herein. A head-mounted display system for presenting mixed reality presentations including a processor subsystem to implement and interface with: a context engine to determine a user context of a user of a head-mounted display (HMD); a picture-in-picture (PIP) coordinator engine to determine a picture-in-picture (PIP) content for display in a PIP view of the HMD; and a graphics driver to simultaneously display an alternate reality content in a main view of the HMD and the PIP content in the PIP view of the HMD.

### TECHNICAL FIELD

Embodiments described herein generally relate to computing, and in particular, to systems and methods for mixed reality presentations.

### BACKGROUND

Augmented reality (AR) viewing may be defined as a live view of a real-world environment whose elements are supplemented (e.g., augmented) by computer-generated sensory input such as sound, video, graphics, or GPS data. Virtual reality (VR) viewing may be defined as a fully simulated world, within which the viewer may interact. A head-mounted display (HMD), also sometimes referred to as a helmet-mounted display, is a device worn on the head or as part of a helmet that is able to project images in front of one or both eyes. An HMD may be used for various applications including AR or VR simulations. HMDs are used in a variety of fields such as entertainment, military, gaming, sporting, engineering, and training

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating an augmented reality (AR) and virtual reality (VR) system, according to an embodiment:

FIG. 2 is a flowchart illustrating a process for presenting a PIP screen in an AR/VR environment, according to an embodiment:

FIG. 3 is a block diagram illustrating an HMD that is capable of presenting a PIP screen in an AR/VR environment, according to an embodiment:

FIG. 4 is a chart illustrating some rules that a PIP coordinator engine may use, in an embodiment;

FIGS. 5A-C are schematic diagrams illustrating a transition from one VR environment to another VR environment, according to an embodiment;

FIG. 6 is a flowchart illustrating a method for presenting mixed reality presentations, according to an embodiment; and

FIG. 7 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Virtual reality (VR) makes a user feel completely immersed in an alternative environment. This type of experience is useful for training, entertainment, and other scenarios. Augmented reality (AR) is similar to VR in that computer-generated images are presented to a user, which the user may interact with, but in AR the images are overlaid on real-world objects.

Picture-in-picture (PIP) is a technology that overlays content on top of other content. In the context of television, PIP may be used to view two channels: one on the main screen and the second on a PIP screen. The PIP screen may be any size relative to the main screen. In some instances, the PIP screen is a quarter of the main screen, half of the main screen, or a floating frame that takes up less than a quarter of the area of the main screen.

Currently, when a user is immersed in VR, they are isolated to one type of content. There is no way for the user to view alternative content. Similarly, when the user is experiencing AR, there needs to be a way for the user to view alternative content available to the user. Alternative content may be another VR or AR session of available to the user to experience, or an AR or VR session of another user. The content displayed in the PIP screen may be configured based on the user's context. Various interactions with the PIP screen to activate the alternative content are described in this document.

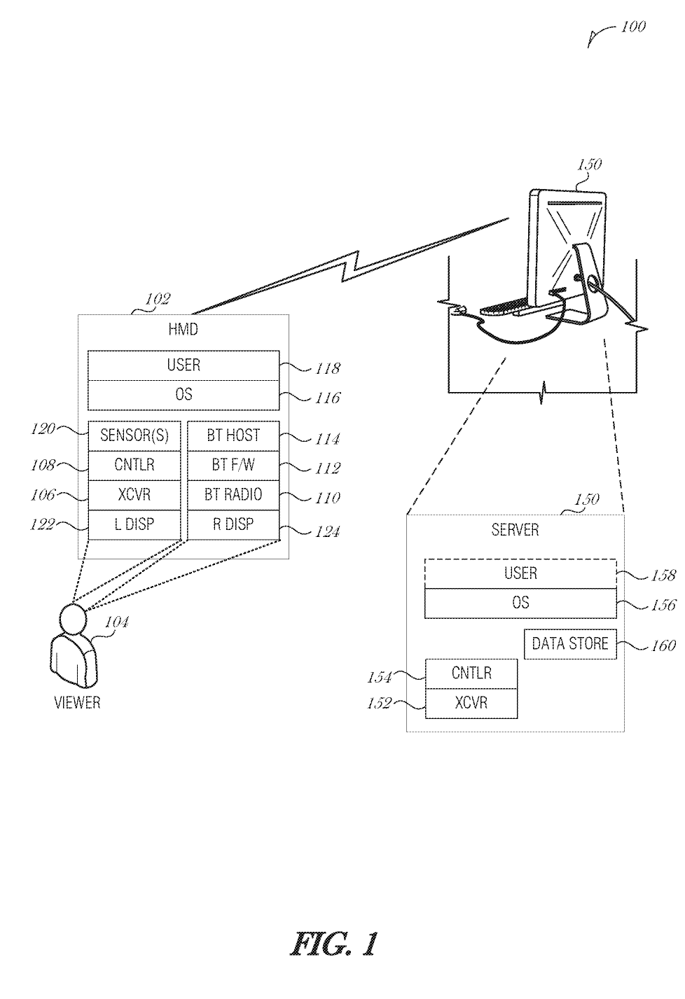

FIG. 1 is a block diagram illustrating an augmented reality (AR) and virtual reality (VR) system 100, according to an embodiment. The VR system 100 may include a head-mounted display 102 (HMD) and a server 150. The AR/VR system 100 may be installed and executed at a local site, such as at an office or home, or installed and executed from a remote site, such as a data center or a cloud service. Portions of the AR/VR system 100 may run locally while other portions may run remotely (with respect to the local elements). The HMD 102 may be communicatively coupled with the server 150 via a hardwired connection (e.g., DVI, DisplayPort, HDMI, VGA, Ethemet, USB, FireWire, AV cables, and the like), or via a wireless connection (e.g., Bluetooth, Wi-Fi, and the like).

The HMD 102 may include a transceiver 106, capable of both sending and receiving data, and be controlled by a controller 108. The transceiver 106 and controller 108 may be used to communicate over various wireless networks, such as a Wi-Fi network (e.g., according to the IEEE 802.11 family of standards); cellular network, for example, a network designed according to the Long-Term Evolution (LTE), LTE-Advanced, 5G, or Global System for Mobile Communications (GSM) families of standards; or the like.

The HMD 102 may include Bluetooth hardware, firmware, and software to enable Bluetooth connectivity according to the IEEE 802.15 family of standards. In an example, the HMD 102 includes a Bluetooth radio 110 controlled by Bluetooth firmware 112 and a Bluetooth host 114.

The HMD 102 may include a left display monitor 122 to display an image to a left eye of a viewer 104, and a right display monitor 124 to display an image to a right eye of the viewer 104. However, this should not be construed as limiting, as in some embodiments, the HMD 102 may include only one video display, which may display both an image associated with the left eye and an image associated with the right eye of the viewer, or may display a two-dimensional (2D) image on a set of display monitors.

The HMD 102 may also include a set of sensors 120. The sensors 120 may include a digital still camera or video camera to receive images of the environment adjacent to or surrounding the HMD 102 or within a line of sight of the HMD 102, e.g., the environment adjacent to or surrounding the viewer 104 or within a line of sight of the viewer 104 when the viewer 104 is using the HMD 102. The environment may be considered to be adjacent to the viewer 104 when the viewer 104 can touch or interact with the environment, e.g., when the viewer is seated near another person on a train and can touch that person or have a conversation with that person. The environment may also be considered to be surrounding the viewer 104 when the viewer 104 is able to see the environment, e.g., when the environment is within a line of sight of the viewer 104. The displayed image may be modified to incorporate a representation of the image of the environment within a line of sight of the HMD 102. The displayed image may be overlaid on a view of the real-world environment (e.g., in the case of AR).

The sensors 120 may also include a microphone to receive audio of the environment. The sensors 120 may also include a motion detector, e.g., an accelerometer, to detect movement of the HMD 102, e.g., movement of the viewer's head when the viewer 104 wears the HMD 102. The motion detector may also detect other movements of the viewer 104, e.g., the viewer 104 sitting down, standing up, or head turning.

The sensors 120 may also include a proximity sensor to detect proximity of the HMD 102 to people or objects in the real-world environment surrounding the HMD 102. The sensors 120 may also include one or more of temperature sensors, humidity sensors, light sensors, infrared (IR) sensors, heart rate monitors, vibration sensors, tactile sensors, conductance sensors, etc., to sense the viewer's activities and current state, accept input, and also to sense information about the viewer's environment.

An operating system 116 may interface with the controller 108 and Bluetooth host 114. The operating system 116 may be a desktop operating system, embedded operating system, real-time operating system, proprietary operating system, network operating system, and the like. Examples include, but are not limited to, Windows® NT (and its variants), Windows® Mobile, Windows® Embedded, Mac OS®, Apple iOS, Apple WatchOS®, UNIX, Android™, JavaOS, Symbian OS. Linux, and other suitable operating system platforms.

A communication controller (not shown) may be implemented in hardware, in firmware, or in the operating system 116. The communication controller may act as an interface with various hardware abstraction layer (HAL) interfaces, e.g., device drivers, communication protocol stacks, libraries, and the like. The communication controller is operable to receive user input (e.g., from a system event or by an express system call to the communication controller), and interact with lower-level communication devices (e.g., Bluetooth radio, Wi-Fi radio, cellular radio, etc.) based on the user input. The communication controller may be implemented, at least in part, in a user-level application that makes calls to one or more libraries, device interfaces, or the like in the operating system 116, to cause communication devices to operate in a certain manner.

A user application space 118 on the HMD 102 is used to implement user-level applications, controls, user interfaces, and the like, for the viewer 104 to control the HMD 102. An application, app, extension, control panel, or other user-level executable software program may be used to control access to the HMD 102. For example, an executable file, such as an app, may be installed on the HMD 102 and operable to communicate with a host application installed on the server 150. As another example, an application executing in user application space 118 (or OS 116) may work with the sensors 120 to detect gestures performed by the viewer 104.

The server 150 may include an operating system 156, a file system, database connectivity, radios, or other interfaces to provide a VR experience to the HMD 102. In particular, the server 150 may include, or be communicatively connected to, a radio transceiver 152 to communicate with the HMD 102. A respective controller 154 may control the radio transceiver 152 of the server 150, which in turn may be connected with and controlled via the operating system 156 and user-level applications 158.

In operation, the viewer 104 may interact with a AR/VR environment using the HMD 102. When viewing the environment, a PIP screen may be displayed. The PIP screen may be displayed in response to a triggering action. The action may be a keyword the viewer 104 speaks, a trigger gesture that the viewer 104 performs, or a user interface (e.g., a button the HMD 102) that the viewer 104 presses. This is a non-limited list of actions and it is understood that additional actions, or combinations of actions, may be performed to control the PIP screen. The viewer 104 may toggle the visibility of the PIP screen, or control the PIP screen position, size, translucency, or content. More than one PIP screen may be presented in the AR/VR environment.

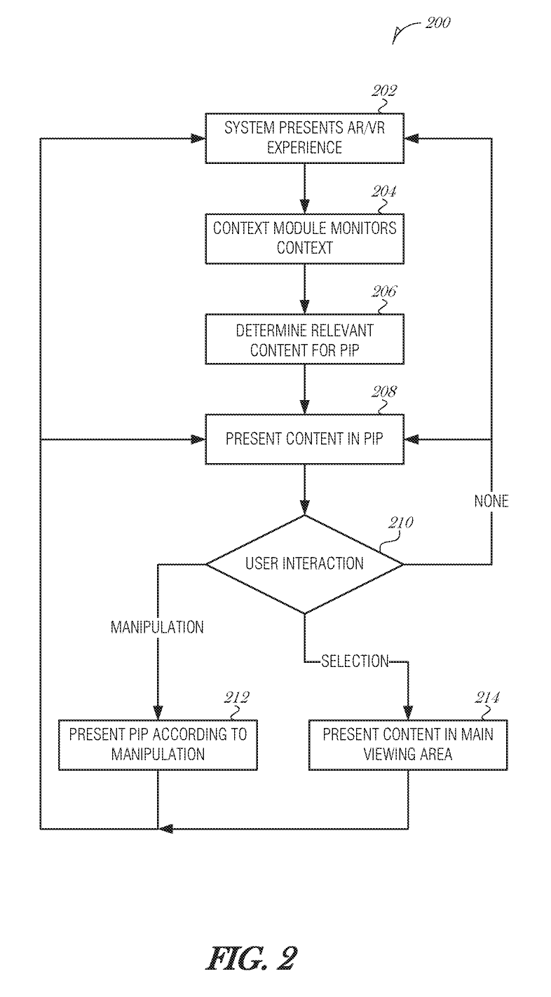

FIG. 2 is a flowchart illustrating a process 200 for presenting a PIP screen in an AR/VR environment, according to an embodiment. The system presents an AR/VR experience (operation 202) to a user. The AR/VR presentation is presented in a main presentation area (or main viewing area). For AR, the main presentation area is the user's field of view through a transparent or translucent screen on the HMD. For VR, the main presentation area is the VR environment presented to the user in the HMD-typically the entire display area in the HMD. The PIP screen is overlaid on the main presentation area. In AR, the PIP screen may overlay or obscure some or all of a computer-generated element in the main presentation area. In VR, the PIP will necessarily overlay a portion of a computer-generated element in the main presentation area.

A context engine monitors the context of the user (operation 204). The context may include various aspects of the user's environment, the user, the user's schedule, or the like. Examples aspects include, but are not limited to schedule, location, social circumstances (e.g., people nearby), posture (e.g., sitting, standing), activity (e.g., walking, exercising), etc. The context engine may also monitor aspects of the current AR or VR experiences of other users who are engaged with the user. For example, when the user is involved in a cooperative VR game, the context engine may monitor the VR experiences of other players on the user's team. In such a system the users may have to set privacy settings so that the system is able to access data, such as their current AR/VR content.

A coordinator engine may determine relevant content for the PIP screen (operation 206). The coordinator engine may work with the context engine to determine available content, reference user preferences to determine a priority or preference of content to present in a PIP screen, or access a rule database to determine which content is allowed or compatible with the existing main presentation content. The coordinator engine selects content to present in the PIP (operation 208). The user may interact with the content (decision operation 210).

If the user does not interact with the PIP screen or its contents, then the process 200 returns to operation 202 to present the AR/VR experience with the PIP screen and continue to monitor context. The process 200 may also return to present the content in the PIP (operation 208) and await for further any user interactions.

If the user manipulates the PIP screen, then the PIP screen is modified and displayed in the modified form (operation 212). Examples of how the user may interact and modify the PIP screen include, but are not limited to changing the size, position, or content of the PIP screen. For instance, the user may interact with the PIP screen to stretch or shrink the PIP in AR/VR using gestures.

In another instance, the user may “change the channel” of the PIP screen to change to different content. For example, the user may be in a cooperative gaming experience with four other players on their team. The user may selectively rotate through the first-person presentations of the other players on her team using a swiping motion over the PIP screen.

In yet another instance, the user may move the PIP screen's position in the main viewing area. For example, the PIP screen may be less intrusive or distracting to the user when placed in a lower right quadrant of the user's view. The default position of the PIP screen may be an upper left area of the user's view, and by “grabbing” the PIP screen, the user may move the PIP screen to the desired location. Grabbing the PIP screen or other interactions with the PIP screen may be provided using conventional AR/VR techniques, such as tracking the user's hands in space in front of the user, detecting a gesture (e.g., pinching gesture), registering the location of the user's hands, and detecting another gesture (e.g., a release gesture).

After interacting with the PIP screen, the process 200 may return to present the content in the PIP (operation 208) and await for further user interactions. The process 200 may) also simultaneously, or substantially concurrently, return to operation 202 to continue and monitor the context and adjust the content of the PIP accordingly.

If the user selects the PIP screen to replace the main viewing area's content, then the content of the main viewing screen and the PIP screen are swapped (operation 214). Depending on the circumstances, the user may be able to interact with the swapped content. For instance, if the PIP screen displays an optional game to the user, the user may swap the content from the PIP screen to the main viewing area and play the optional game. In another instance, if the PIP screen displays a teammate's point-of-view, then after swapping content, the user may not be able to interact with the new main screen content because it is being used by the other user. In yet another instance, the teammate's experience may be used as a shared experience, where both the user and the teammate are able to interact with the same virtual environment. In this case, after swapping the PIP content with the main area content, the user may interact with the environment along with the teammate. Other functions may be provided before and after swapping content in other embodiments.

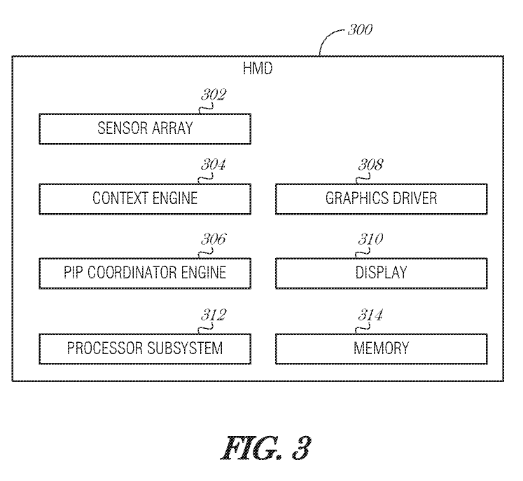

FIG. 3 is a block diagram illustrating an HMD 300 that is capable of presenting a PIP screen in an AR/VR environment, according to an embodiment. The HMD 300 includes a sensor array 302, a context engine 304, a PIP coordinator engine 306, a graphics driver 308, a display 310, a processor subsystem 312, and memory 314.

The HMD 300 is equipped with onboard systems that monitor the state of the HMD 300 and automatically adjust the display 310 provided by the HMD 300 based on the state. The HMD 300 may be equipped with one or more sensors (e.g., accelerometers, gyrometers, or magnetometers) to determine the state of the HMD 300 and optionally the state of the user.

The sensor array 302 may include various sensors such as cameras, light meters, microphones, or the like to monitor the environment around the user of the HMD 300. The sensor array 302 may include one or more cameras able to capture visible light, infrared, or the like, and may be used as 2D or 3D cameras (e.g., depth camera). The sensor array 302 may be configured to detect a gesture made by the user (wearer) and the processor subsystem 312 may use the gesture to trigger various PIP screen functions or other interactions with a PIP screen.

The HMD 300 may optionally include one or more inward facing sensors (not shown) to sense the user's face, skin, or eyes, and determine a relative motion between the HMD 300 and the detected face, skin, or eyes. The inward facing sensors may be mounted to an interior portion of the HMD 300, such as in the goggles housing, on the lens, or on a projecting portion of the HMD 300, in various embodiments.

The HMD 300 includes a display 310. An image or multiple images may be projected onto the display 310, such as is done by a microdisplay. Alternatively, some or all of the display 310 may be an active display (e.g., an organic light-emitting diode (OLED)) able to produce an image in front of the user. The display 310 also may be provided using retinal projection of various types of light, using a range of mechanisms, including (but not limited to) waveguides, scanning raster, color-separation and other mechanisms. In some examples, the display 310 is able to produce a high dynamic range to match real-world characteristics.

The display 310 may be a see-through display surface so that the user is able to see at least a portion of the real-world environment around the user. Images may be projected on the see-through display surface to augment the user's perception of the real-world with such images. The display 310 may be made of a transparent or translucent material, such as glass, plastic, or the like.

The context engine 304 may be implemented in hardware, as hardware configured by software, or as a service provided by the processor subsystem 312. The context engine 304 interfaces with the sensor array 302 to monitor the user's context. The context engine 304 may also communicate with network resources to obtain the user's location, schedule, or other contextual information. Additionally, or in the alternative, the context engine 304 may refer to other data sources, such as a user's calendar, schedule, date book, appointment log, or the like, to determine where the user is or should be, or where the user is scheduled to be in the future.

The memory 314 may include instructions to perform the various functions described herein, which when executed by the processor subsystem 312 may implement the functions. The memory 314 may also include user profiles to configure or control the context engine 304 or the PIP coordinator engine 306. User profiles may define the size, position, or preferred content of the PIP screen. The user profile may also include ratings of previous experiences, games that the user has participated in, general interests, etc. The user profile may be modified by, or include, a machine learning process to monitor user choices and actions, and then determine user preferences from the user's past actions.

Based on the context provided by the context engine 304 and the user profile, potentially along with data from other data sources or sensors, the PIP coordinator engine 306 selects content to be displayed in a PIP screen. If there are multiple PIP screens, then the PIP coordinator engine 306 may select content for some or all of the PIP screens. The PIP coordinator engine 306 may operate on rules provided by a system designer, a user, or formed from machine learning processes.

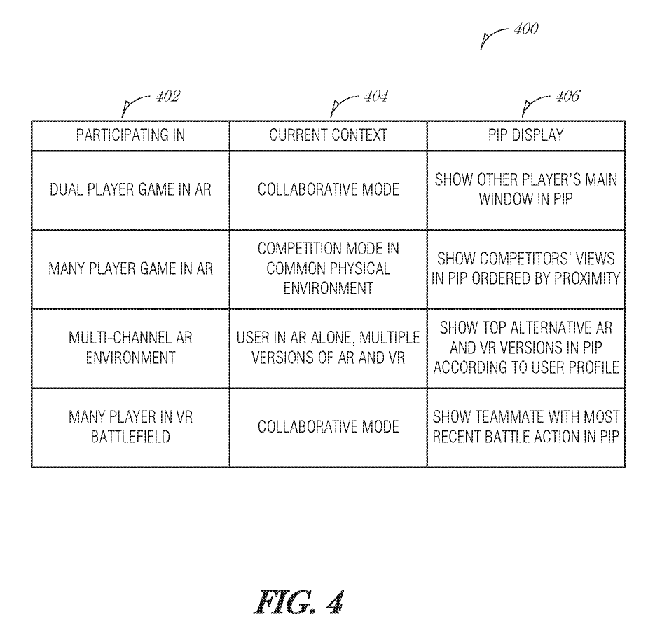

FIG. 4 is a chart 400 illustrating some rules that a PIP coordinator engine 306 may use, in an embodiment. The chart 400 includes a column 402 indicating what activity the user is participating in, a column 404 indicating which context the user is active in, and a column 406 indicating what to show on a PIP screen. It is understood that the chart 400 may include more or fewer rules depending on system design.

The rules in chart 400 are based on whether the user is playing in AR or VR, whether it is a single-player environment or a multi-player environment, and whether the players (if in a multi-player environment) are in collaborative or competitive mode. For instance, the first rule refers to a dual-player game in AR where the players are working in a collaborative fashion. In this situation, the PIP coordinator engine 306 may select to display the other player's main window in the user's PIP screen. The user may alter the default displayed content, for example, by way of the process 200 of FIG. 2. By viewing what her partner sees in the PIP screen, the user is able to experience the first-person experience and look in on her partner's experience, augmenting the game play on the whole.

In some example implementations, there may be more than one version of content available to experience. For example, a game may be playable as either an AR game or a VR game. When playing in one mode, the other mode may be viewed in a PIP screen to allow the user to switch between the two modes, preview the other mode, or enhance the experience of whichever mode is being used as the primary mode (e.g., the one displayed in the main viewing area).

In a larger multi-player game, the user may be on a team of four, five, or more players. Using a multi-PIP implementation, the user may have more than one PIP screen available to show teammates' activities. For instance, each teammate may be displayed in an assigned PIP screen so that the user is able to see what other teammates are doing. In another implementation, one or more PIP screens may be displayed where the teammates with the most recent game activity may be displayed in the PIP screens.

A wide-array of content for the PIP screen may be available depending on the game being played, the activity being performed, the time of day, the user's preferences, the user's social circle, the activities of the user's social circle, the user's history of game play or activities, the user's schedule, or other components of the user context.

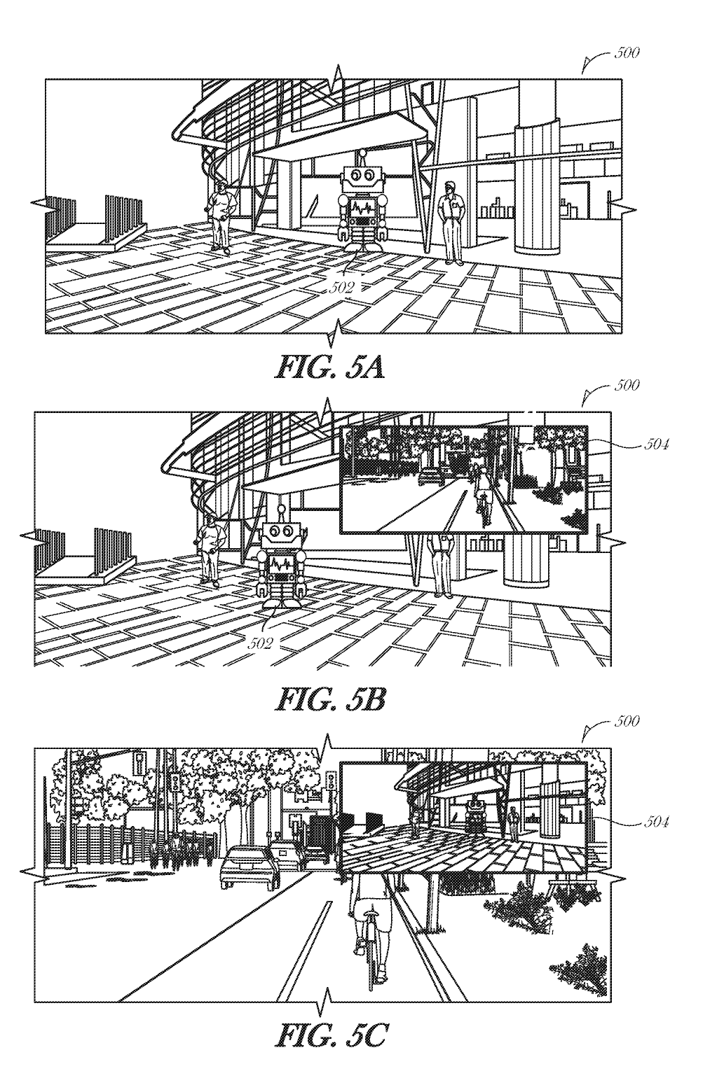

FIGS. 5A-C are schematic diagrams illustrating a transition from one VR environment to another VR environment, according to an embodiment. FIG. 5A illustrates an AR environment 500. The AR environment 500 is an outdoor real-world space with AR content 502. FIG. 5B illustrates the VR environment 500 with a PIP screen 504 of alternative content. The alternative content may be a game that a friend is playing, a preview of a VR game, or other content. The content of the PIP screen 504 may be selected based on the user's context. FIG. 5C illustrates the VR environment 500 with the content from the PIP screen 504 swapped with the main viewing area content.

Thus, returning to FIG. 3, the HMD 300 may be implemented as system for presenting mixed reality presentations. Mixed reality presentations include any combination of AR with AR or VR, or VR with AR or VR, displayed at the same time to the user. The mix reality presentations may be displayed in a split-screen, main screen and PIP screen, or the like. Each screen includes its own content of AR or VR, which differs from the AR or VR being presented in the other screen(s).

The HMD 300 includes a context engine 304 to determine a user context of a user of a head-mounted display (HMD). In an embodiment, to determine the user context, the context engine 304 is to interface with a sensor array 302 of the HMD 300 to determine a location of the user. The sensor array 302 may include a positioning unit, a camera, or a microphone, in various embodiments.

In an embodiment, to determine the user context, the context engine 304 is to interface with a sensor array 302 of the HMD 300 to determine an activity of the user. The activities may include games the user is playing, a physical activity (e.g., walking, sitting, standing, etc.) that the user is performing, or the like.

In an embodiment, to determine the user context, the context engine 304 is to interface with a sensor array 302 of the HMD 300 to determine a person in proximity to the user. A camera, short-range radio network, or other mechanism may be used to detect or determine whether someone is nearby the user. The person may be identified, for example, using image analysis and facial recognition.

In an embodiment, to determine the user context, the context engine 304 is to determine an appointment scheduled for the user. The context engine 304 may access an electronic database either at the HMD 300 or at a network location accessibly by the HMD 300. Determining the appointment provides insight into the user's activities, daily plan, location, and the like.

In an embodiment, to determine the user context, the context engine 304 is to access user preferences, the user preferences to configure the display of the PIP content. User preferences may be stored at the HMD 300 or at a network location accessibly by the HMD 300. The user may store various user preferences to control the display of the PIP view, the PIP content, along with other aspects of the HMD's operation.

The HMD 300 also includes a picture-in-picture (PIP) coordinator engine 306 to determine a picture-in-picture (PIP) content for display in a PIP view of the HMD. In an embodiment, to determine the PIP content for display in the PIP view of the HMD 300, the PIP coordinator engine 306 is to access a rule database to select the PIP content from a plurality of PIP content based on the user context. Rules may be designated for various contexts that the user may find herself in, such as during gaming, in social events, at work, or at home.

In an embodiment, to determine the PIP content for display in the PIP view of the HMD 300, the PIP coordinator engine 306 is to receive an indication of a user input, the user input selecting the PIP view, and swap the PIP content in PIP view with alternate reality content in the main view, placing the PIP content in the main view and the alternate reality content in the PIP view. The user input may be a gesture, spoken command, hardware user interface element (e.g., a button on the housing of the HMD 300), or the like.

In an embodiment, to display the alternate reality content in the main view of the HMD and the PIP content in the PIP view of the HMD, the graphics driver is to display the PIP view as a floating window in the main view. The floating window may appear opaque or translucent. The translucency may be controlled by a user preference setting.

The HMD 300 also includes a graphics driver 308 to simultaneously display an alternate reality content in a main view of the HMD 300 and the PIP content in the PIP view of the HMD 300. Alternate reality content refers to either virtual reality content or augmented reality content. The main view is also referred to as the main screen, main viewing area, or primary viewing area. The main view is where the operative alternate reality content is displayed to the user. The PIP view is typically a smaller area that is overlaid or incorporated into the main view of the HMD 300. The PIP view may be resizable, repositionable, or otherwise configurable. Multiple PIP views may exist in some embodiments.

The main view content may be AR or VR content, and the PIP view content may be AR or VR content. The PIP view content may provide a preview to alternative versions of the main view, previews for other content, other people's content, or the like.

As such, in an embodiment, the alternate reality content comprises virtual reality content, and to display the alternate reality content in the main view of the HMD 300 and the PIP content in the PIP view of the HMD 300, the graphics driver 308 is to display second virtual reality content in the PIP view. In a further embodiment, to display the second virtual reality content in the PIP view, the graphics driver 308 is to display virtual reality content of a teammate of the user in the PIP view. In a related embodiment, to display the second virtual reality content in the PIP view, the graphics driver 308 is to display a preview of a different version of the virtual reality content in the PIP view.

In another embodiment, the alternate reality content comprises augmented reality content, and to display the alternate reality content in the main view of the HMD 300 and the PIP content in the PIP view of the HMD 300, the graphics driver 308 is to display virtual reality content in the PIP view. In a further embodiment, to display virtual reality content in the PIP view, the graphics driver 308 is to display virtual reality content of a teammate of the user in the PIP view. In a related embodiment, to display virtual reality content in the PIP view, the graphics driver 308 is to display a preview of a different version of the augmented reality content in the PIP view.

In another embodiment, the alternate reality content comprises virtual reality content, and to display the alternate reality content in the main view of the HMD 300 and the PIP content in the PIP view of the HMD 300, the graphics driver 308 is to display augmented reality content in the PIP view. In a further embodiment, to display augmented reality content in the PIP view, the graphics driver 308 is to display augmented reality content of a teammate of the user in the PIP view. In a related embodiment, to display augmented reality content in the PIP view, the graphics driver 308 is to display a preview of a different version of the augmented reality content in the PIP view.

In another embodiment, the alternate reality content comprises virtual reality content, and to display the alternate reality content in the main view of the HMD 300 and the PIP content in the PIP view of the HMD 300, the graphics driver 308 is to display second virtual reality content in the PIP view. In a further embodiment, to display the second virtual reality content in the PIP view, the graphics driver 308 is to display virtual reality content of a teammate of the user in the PIP view. In a related embodiment, to display the second virtual reality content in the PIP view, the graphics driver 308 is to display a preview of a different version of the virtual reality content in the PIP view.

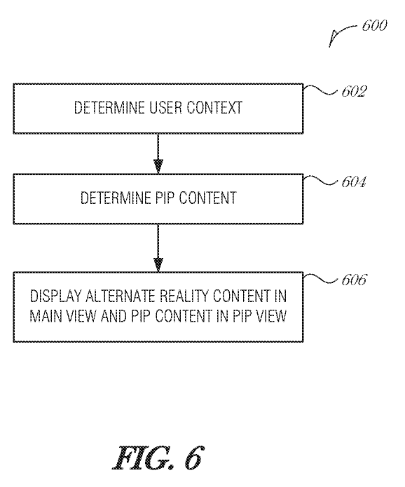

FIG. 6 is a flowchart illustrating a method 600 for presenting mixed reality presentations, according to an embodiment. At 602, a user context of a user of a head-mounted display (HMD) is determined. In an embodiment, the user context comprises interfacing with a sensor array of the HMD to determine a location of the user. In an embodiment, determining the user context comprises interfacing with a sensor array of the HMD to determine an activity of the user. In an embodiment, determining the user context comprises interfacing with a sensor array of the HMD to determine a person in proximity to the user. In embodiments, the sensor array comprises a positioning unit, a camera, or a microphone.

In an embodiment, determining the user context comprises determining an appointment scheduled for the user. In an embodiment, determining the user context comprises accessing user preferences, the user preferences to configure the display of the PIP content.

At 604, a picture-in-picture (PIP) content for display in a PIP view of the HMD is determined. In an embodiment, determining the PIP content for display in the PIP view of the HMD comprises accessing a rule database to select the PIP content from a plurality of PIP content based on the user context.

In an embodiment, determining the PIP content for display in the PIP view of the HMD comprises receiving an indication of a user input, the user input selecting the PIP view and swapping the PIP content in PIP view with alternate reality content in the main view, placing the PIP content in the main view and the alternate reality content in the PIP view.

At 606, an alternate reality content in a main view of the HMD and the PIP content in the PIP view of the HMD are displayed simultaneously.

In an embodiment, displaying the alternate reality content in the main view of the HMD and the PIP content in the PIP view of the HMD comprises displaying the PIP view as a floating window in the main view.

In an embodiment, the alternate reality content comprises virtual reality content, and displaying the alternate reality content in the main view of the HMD and the PIP content in the PIP view of the HMD comprises displaying second virtual reality content in the PIP view. In a further embodiment, displaying the second virtual reality content in the PIP view comprises displaying virtual reality content of a teammate of the user in the PIP view. In a related embodiment, displaying the second virtual reality content in the PIP view comprises displaying a preview of a different version of the virtual reality content in the PIP view.

In an embodiment, the alternate reality content comprises augmented reality content, and displaying the alternate reality content in the main view of the HMD and the PIP content in the PIP view of the HMD comprises displaying virtual reality content in the PIP view. In a further embodiment, displaying virtual reality content in the PIP view comprises displaying virtual reality content of a teammate of the user in the PIP view. In a related embodiment, displaying virtual reality content in the PIP view comprises displaying a preview of a different version of the augmented reality content in the PIP view.

In an embodiment, the alternate reality content comprises virtual reality content, and displaying the alternate reality content in the main view of the HMD and the PIP content in the PIP view of the HMD comprises displaying augmented reality content in the PIP view. In a further embodiment, displaying augmented reality content in the PIP view comprises displaying augmented reality content of a teammate of the user in the PIP view. In a related embodiment, displaying augmented reality content in the PIP view comprises displaying a preview of a different version of the augmented reality content in the PIP view.

In an embodiment, the alternate reality content comprises virtual reality content, and displaying the alternate reality content in the main view of the HMD and the PIP content in the PIP view of the HMD comprises displaying second virtual reality content in the PIP view. In a further embodiment, displaying the second virtual reality content in the PIP view comprises displaying virtual reality content of a teammate of the user in the PIP view. In a related embodiment, displaying the second virtual reality content in the PIP view comprises displaying a preview of a different version of the virtual reality content in the PIP view.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of circuits, components, modules, or engines, which for the sake of consistency are termed engines, although it will be understood that these terms may be used interchangeably. Engines are tangible entities capable of performing specified operations and may be configured or arranged in a certain manner. Engines may be realized as hardware circuitry, as well one or more processors programmed via software or firmware (which may be stored in a data storage device interfaced with the one or more processors), in order to carry out the operations described herein. In this type of configuration, an engine includes both, the software, and the hardware (e.g., circuitry) components. In an example, circuits may be arranged (e.g., internally or with respect to external entities such as other circuits) in a specified manner as an engine. In an example, the whole or part of one or more computer systems (e.g., a standalone, client or server computer system) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which engines are temporarily configured, each of the engines need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time. In view of the above definition, engines are structural entities that have both, a physical structure, and an algorithmic structure. According to some embodiments, engines may constitute the structural means for performing certain algorithmic functions described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

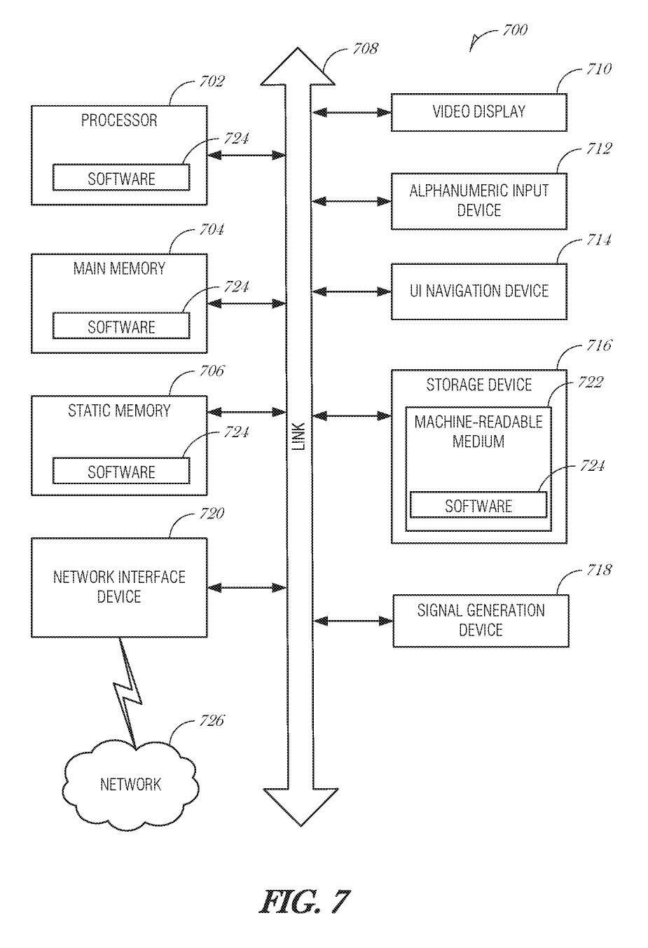

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a head-mounted display, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a head-mounted display system for presenting mixed reality presentations, the system comprising: a processor subsystem to implement and interface with: a context engine to determine a user context of a user of a head-mounted display (HMD); a picture-in-picture (PIP) coordinator engine to determine a picture-in-picture (PIP) content for display in a PIP view of the HMD; and a graphics driver to simultaneously display an alternate reality content in a main view of the HMD and the PIP content in the PIP view of the HMD.

In Example 2, the subject matter of Example 1 optionally includes wherein to determine the user context, the context engine is to interface with a sensor array of the HMD to determine a location of the user.

In Example 3, the subject matter of any one or more of Examples 1-2 optionally include wherein to determine the user context, the context engine is to interface with a sensor array of the HMD to determine an activity of the user.

In Example 4, the subject matter of any one or more of Examples 1-3 optionally include wherein to determine the user context, the context engine is to interface with a sensor array of the HMD to determine a person in proximity to the user.

In Example 5, the subject matter of any one or more of Examples 2-4 optionally include wherein the sensor array comprises a positioning unit, a camera, or a microphone.

In Example 6, the subject matter of any one or more of Examples 1-5 optionally include wherein to determine the user context, the context engine is to determine an appointment scheduled for the user.

In Example 7, the subject matter of any one or more of Examples 1-6 optionally include wherein to determine the user context, the context engine is to access user preferences, the user preferences to configure the display of the PIP content.

In Example 8, the subject matter of any one or more of Examples 1-7 optionally include wherein to determine the PIP content for display in the PIP view of the HMD, the PIP coordinator is to access a rule database to select the PIP content from a plurality of PIP content based on the user context.

In Example 9, the subject matter of any one or more of Examples 1-8 optionally include wherein to determine the PIP content for display in the PIP view of the HMD, the PIP coordinator is to: receive an indication of a user input, the user input selecting the PIP view; and swap the PIP content in PIP view with alternate reality content in the main view, placing the PIP content in the main view and the alternate reality content in the PIP view.

In Example 10, the subject matter of any one or more of Examples 1-9 optionally include wherein to display the alternate reality content in the main view of the HMD and the PIP content in the PIP view of the HMD, the graphics driver is to display the PIP view as a floating window in the main view.

In Example 11, the subject matter of any one or more of Examples 1-10 optionally include wherein the alternate reality content comprises virtual reality content, and wherein to display the alternate reality content in the main view of the HMD and the PIP content in the PIP view of the HMD, the graphics driver is to display second virtual reality content in the PIP view.

In Example 12, the subject matter of Example 11 optionally includes wherein to display the second virtual reality content in the PIP view, the graphics driver is to display virtual reality content of a teammate of the user in the PIP view.

In Example 13, the subject matter of any one or more of Examples 11-12 optionally include wherein to display the second virtual reality content in the PIP view, the graphics driver is to display a preview of a different version of the virtual reality content in the PIP view.

In Example 14, the subject matter of any one or more of Examples 1-13 optionally include wherein the alternate reality content comprises augmented reality content, and wherein to display the alternate reality content in the main view of the HMD and the PIP content in the PIP view of the HMD, the graphics driver is to display virtual reality content in the PIP view.

In Example 15, the subject matter of Example 14 optionally includes wherein to display virtual reality content in the PIP view, the graphics driver is to display virtual reality content of a teammate of the user in the PIP view.

In Example 16, the subject matter of any one or more of Examples 14-15 optionally include wherein to display virtual reality content in the PIP view, the graphics driver is to display a preview of a different version of the augmented reality content in the PIP view.

In Example 17, the subject matter of any one or more of Examples 1-16 optionally include wherein the alternate reality content comprises virtual reality content, and wherein to display the alternate reality content in the main view of the HMD and the PIP content in the PIP view of the HMD, the graphics driver is to display augmented reality content in the PIP view.

In Example 18, the subject matter of Example 17 optionally includes wherein to display augmented reality content in the PIP view, the graphics driver is to display augmented reality content of a teammate of the user in the PIP view.

In Example 19, the subject matter of any one or more of Examples 17-18 optionally include wherein to display augmented reality content in the PIP view, the graphics driver is to display a preview of a different version of the augmented reality content in the PIP view.

In Example 20, the subject matter of any one or more of Examples 1-19 optionally include wherein the alternate reality content comprises virtual reality content, and wherein to display the alternate reality content in the main view of the HMD and the PIP content in the PIP view of the HMD, the graphics driver is to display second virtual reality content in the PIP view.

In Example 21, the subject matter of Example 20 optionally includes wherein to display the second virtual reality content in the PIP view, the graphics driver is to display virtual reality content of a teammate of the user in the PIP view.

In Example 22, the subject matter of any one or more of Examples 20-21 optionally include wherein to display the second virtual reality content in the PIP view, the graphics driver is to display a preview of a different version of the virtual reality content in the PIP view.

Example 23 is a method of presenting mixed reality presentations, the method comprising: determining a user context of a user of a head-mounted display (HMD); determining a picture-in-picture (PIP) content for display in a PIP view of the HMD; and displaying simultaneously an alternate reality content in a main view of the HMD and the PIP content in the PIP view of the HMD.

In Example 24, the subject matter of Example 23 optionally includes wherein determining the user context comprises interfacing with a sensor array of the HMD to determine a location of the user.

In Example 25, the subject matter of any one or more of Examples 23-24 optionally include wherein determining the user context comprises interfacing with a sensor array of the HMD to determine an activity of the user.

In Example 26, the subject matter of any one or more of Examples 23-25 optionally include wherein determining the user context comprises interfacing with a sensor array of the HMD to determine a person in proximity to the user.

In Example 27, the subject matter of any one or more of Examples 24-26 optionally include wherein the sensor array comprises a positioning unit, a camera, or a microphone.

In Example 28, the subject matter of any one or more of Examples 23-27 optionally include wherein determining the user context comprises determining an appointment scheduled for the user.

In Example 29, the subject matter of any one or more of Examples 23-28 optionally include wherein determining the user context comprises accessing user preferences, the user preferences to configure the display of the PIP content.

In Example 30, the subject matter of any one or more of Examples 23-29 optionally include wherein determining the PIP content for display in the PIP view of the HMD comprises accessing a rule database to select the PIP content from a plurality of PIP content based on the user context.

In Example 31, the subject matter of any one or more of Examples 23-30 optionally include wherein determining the PIP content for display in the PIP view of the HMD comprises: receiving an indication of a user input, the user input selecting the PIP view; and swapping the PIP content in PIP view with alternate reality content in the main view, placing the PIP content in the main view and the alternate reality content in the PIP view.

In Example 32, the subject matter of any one or more of Examples 23-31 optionally include wherein displaying the alternate reality content in the main view of the HMD and the PIP content in the PIP view of the HMD comprises displaying the PIP view as a floating window in the main view.

In Example 33, the subject matter of any one or more of Examples 23-32 optionally include wherein the alternate reality content comprises virtual reality content, and wherein displaying the alternate reality content in the main view of the HMD and the PIP content in the PIP view of the HMD comprises displaying second virtual reality content in the PIP view.

In Example 34, the subject matter of Example 33 optionally includes wherein displaying the second virtual reality content in the PIP view comprises displaying virtual reality content of a teammate of the user in the PIP view.

In Example 35, the subject matter of any one or more of Examples 33-34 optionally include wherein displaying the second virtual reality content in the PIP view comprises displaying a preview of a different version of the virtual reality content in the PIP view.

In Example 36, the subject matter of any one or more of Examples 23-35 optionally include wherein the alternate reality content comprises augmented reality content, and wherein displaying the alternate reality content in the main view of the HMD and the PIP content in the PIP view of the HMD comprises displaying virtual reality content in the PIP view.

In Example 37, the subject matter of Example 36 optionally includes wherein displaying virtual reality content in the PIP view comprises displaying virtual reality content of a teammate of the user in the PIP view.

In Example 38, the subject matter of any one or more of Examples 36-37 optionally include wherein displaying virtual reality content in the PIP view comprises displaying a preview of a different version of the augmented reality content in the PIP view.

In Example 39, the subject matter of any one or more of Examples 23-38 optionally include wherein the alternate reality content comprises virtual reality content, and wherein displaying the alternate reality content in the main view of the HMD and the PIP content in the PIP view of the HMD comprises displaying augmented reality content in the PIP view.

In Example 40, the subject matter of Example 39 optionally includes wherein displaying augmented reality content in the PIP view comprises displaying augmented reality content of a teammate of the user in the PIP view.

In Example 41, the subject matter of any one or more of Examples 39-40 optionally include wherein displaying augmented reality content in the PIP view comprises displaying a preview of a different version of the augmented reality content in the PIP view.

In Example 42, the subject matter of any one or more of Examples 23-41 optionally include wherein the alternate reality content comprises virtual reality content, and wherein displaying the alternate reality content in the main view of the HMD and the PIP content in the PIP view of the HMD comprises displaying second virtual reality content in the PIP view.

In Example 43, the subject matter of Example 42 optionally includes wherein displaying the second virtual reality content in the PIP view comprises displaying virtual reality content of a teammate of the user in the PIP view.

In Example 44, the subject matter of any one or more of Examples 42-43 optionally include wherein displaying the second virtual reality content in the PIP view comprises displaying a preview of a different version of the virtual reality content in the PIP view.

Example 45 is at least one machine-readable medium including instructions, which when executed by a machine, cause the machine to perform operations of any of the methods of Examples 23-44.

Example 46 is an apparatus comprising means for performing any of the methods of Examples 23-44.

Example 47 is an apparatus for presenting mixed reality presentations, the apparatus comprising: means for determining a user context of a user of a head-mounted display (HMD); means for determining a picture-in-picture (PIP) content for display in a PIP view of the HMD; and means for displaying simultaneously an alternate reality content in a main view of the HMD and the PIP content in the PIP view of the HMD.

In Example 48, the subject matter of Example 47 optionally includes wherein the means for determining the user context comprises means for interfacing with a sensor array of the HMD to determine a location of the user.

In Example 49, the subject matter of any one or more of Examples 47-48 optionally include wherein the means for determining the user context comprises means for interfacing with a sensor array of the HMD to determine an activity of the user.

In Example 50, the subject matter of any one or more of Examples 47-49 optionally include wherein the means for determining the user context comprises means for interfacing with a sensor array of the HMD to determine a person in proximity to the user.

In Example 51, the subject matter of any one or more of Examples 48-50 optionally include wherein the sensor array comprises a positioning unit, a camera, or a microphone.

In Example 52, the subject matter of any one or more of Examples 47-51 optionally include wherein the means for determining the user context comprises means for determining an appointment scheduled for the user.

In Example 53, the subject matter of any one or more of Examples 47-52 optionally include wherein the means for determining the user context comprises means for accessing user preferences, the user preferences to configure the display of the PIP content.

In Example 54, the subject matter of any one or more of Examples 47-53 optionally include wherein the means for determining the PIP content for display in the PIP view of the HMD comprises means for accessing a rule database to select the PIP content from a plurality of PIP content based on the user context.

In Example 55, the subject matter of any one or more of Examples 47-54 optionally include wherein the means for determining the PIP content for display in the PIP view of the HMD comprises: means for receiving an indication of a user input, the user input selecting the PIP view; and means for swapping the PIP content in PIP view with alternate reality content in the main view, placing the PIP content in the main view and the alternate reality content in the PIP view.

In Example 56, the subject matter of any one or more of Examples 47-55 optionally include wherein the means for displaying the alternate reality content in the main view of the HMD and the PIP content in the PIP view of the HMD comprises means for displaying the PIP view as a floating window in the main view.

In Example 57, the subject matter of any one or more of Examples 47-56 optionally include wherein the alternate reality content comprises virtual reality content, and wherein the means for displaying the alternate reality content in the main view of the HMD and the PIP content in the PIP view of the HMD comprises means for displaying second virtual reality content in the PIP view.

In Example 58, the subject matter of Example 57 optionally includes wherein the means for displaying the second virtual reality content in the PIP view comprises means for displaying virtual reality content of a teammate of the user in the PIP view.

In Example 59, the subject matter of any one or more of Examples 57-58 optionally include wherein the means for displaying the second virtual reality content in the PIP view comprises means for displaying a preview of a different version of the virtual reality content in the PIP view.

In Example 60, the subject matter of any one or more of Examples 47-59 optionally include wherein the alternate reality content comprises augmented reality content, and wherein the means for displaying the alternate reality content in the main view of the HMD and the PIP content in the PIP view of the HMD comprises means for displaying virtual reality content in the PIP view.

In Example 61, the subject matter of Example 60 optionally includes wherein the means for displaying virtual reality content in the PIP view comprises means for displaying virtual reality content of a teammate of the user in the PIP view.

In Example 62, the subject matter of any one or more of Examples 60-61 optionally include wherein the means for displaying virtual reality content in the PIP view comprises means for displaying a preview of a different version of the augmented reality content in the PIP view.

In Example 63, the subject matter of any one or more of Examples 47-62 optionally include wherein the alternate reality content comprises virtual reality content, and wherein the means for displaying the alternate reality content in the main view of the HMD and the PIP content in the PIP view of the HMD comprises means for displaying augmented reality content in the PIP view.

In Example 64, the subject matter of Example 63 optionally includes wherein the means for displaying augmented reality content in the PIP view comprises means for displaying augmented reality content of a teammate of the user in the PIP view.

In Example 65, the subject matter of any one or more of Examples 63-64 optionally include wherein the means for displaying augmented reality content in the PIP view comprises means for displaying a preview of a different version of the augmented reality content in the PIP view.

In Example 66, the subject matter of any one or more of Examples 47-65 optionally include wherein the alternate reality content comprises virtual reality content, and wherein the means for displaying the alternate reality content in the main view of the HMD and the PIP content in the PIP view of the HMD comprises means for displaying second virtual reality content in the PIP view.

In Example 67, the subject matter of Example 66 optionally includes wherein the means for displaying the second virtual reality content in the PIP view comprises means for displaying virtual reality content of a teammate of the user in the PIP view.

In Example 68, the subject matter of any one or more of Examples 66-67 optionally include wherein the means for displaying the second virtual reality content in the PIP view comprises means for displaying a preview of a different version of the virtual reality content in the PIP view.

Example 69 is at least one machine-readable medium including instructions for presenting mixed reality presentations, which when executed by a machine, cause the machine to perform the operations of: determining a user context of a user of a head-mounted display (HMD); determining a picture-in-picture (PIP) content for display in a PIP view of the HMD; and displaying simultaneously an alternate reality content in a main view of the HMD and the PIP content in the PIP view of the HMD.

In Example 70, the subject matter of Example 69 optionally includes wherein determining the user context comprises interfacing with a sensor array of the HMD to determine a location of the user.

In Example 71, the subject matter of any one or more of Examples 69-70 optionally include wherein determining the user context comprises interfacing with a sensor array of the HMD to determine an activity of the user.

In Example 72, the subject matter of any one or more of Examples 69-71 optionally include wherein determining the user context comprises interfacing with a sensor array of the HMD to determine a person in proximity to the user.

In Example 73, the subject matter of any one or more of Examples 70-72 optionally include wherein the sensor array comprises a positioning unit, a camera, or a microphone.

In Example 74, the subject matter of any one or more of Examples 69-73 optionally include wherein determining the user context comprises determining an appointment scheduled for the user.

In Example 75, the subject matter of any one or more of Examples 69-74 optionally include wherein determining the user context comprises accessing user preferences, the user preferences to configure the display of the PIP content.

In Example 76, the subject matter of any one or more of Examples 69-75 optionally include wherein determining the PIP content for display in the PIP view of the HMD comprises accessing a rule database to select the PIP content from a plurality of PIP content based on the user context.

In Example 77, the subject matter of any one or more of Examples 69-76 optionally include wherein determining the PIP content for display in the PIP view of the HMD comprises: receiving an indication of a user input, the user input selecting the PIP view; and swapping the PIP content in PIP view with alternate reality content in the main view, placing the PIP content in the main view and the alternate reality content in the PIP view.

In Example 78, the subject matter of any one or more of Examples 69-77 optionally include wherein displaying the alternate reality content in the main view of the HMD and the PIP content in the PIP view of the HMD comprises displaying the PIP view as a floating window in the main view.

In Example 79, the subject matter of any one or more of Examples 69-78 optionally include wherein the alternate reality content comprises virtual reality content, and wherein displaying the alternate reality content in the main view of the HMD and the PIP content in the PIP view of the HMD comprises displaying second virtual reality content in the PIP view.

In Example 80, the subject matter of Example 79 optionally includes wherein displaying the second virtual reality content in the PIP view comprises displaying virtual reality content of a teammate of the user in the PIP view.

In Example 81, the subject matter of any one or more of Examples 79-80 optionally include wherein displaying the second virtual reality content in the PIP view comprises displaying a preview of a different version of the virtual reality content in the PIP view.

In Example 82, the subject matter of any one or more of Examples 69-81 optionally include wherein the alternate reality content comprises augmented reality content, and wherein displaying the alternate reality content in the main view of the HMD and the PIP content in the PIP view of the HMD comprises displaying virtual reality content in the PIP view.

In Example 83, the subject matter of Example 82 optionally includes wherein displaying virtual reality content in the PIP view comprises displaying virtual reality content of a teammate of the user in the PIP view.

In Example 84, the subject matter of any one or more of Examples 82-83 optionally include wherein displaying virtual reality content in the PIP view comprises displaying a preview of a different version of the augmented reality content in the PIP view.

In Example 85, the subject matter of any one or more of Examples 69-84 optionally include wherein the alternate reality content comprises virtual reality content, and wherein displaying the alternate reality content in the main view of the HMD and the PIP content in the PIP view of the HMD comprises displaying augmented reality content in the PIP view.

In Example 86, the subject matter of Example 85 optionally includes wherein displaying augmented reality content in the PIP view comprises displaying augmented reality content of a teammate of the user in the PIP view.

In Example 87, the subject matter of any one or more of Examples 85-86 optionally include wherein displaying augmented reality content in the PIP view comprises displaying a preview of a different version of the augmented reality content in the PIP view.

In Example 88, the subject matter of any one or more of Examples 69-87 optionally include wherein the alternate reality content comprises virtual reality content, and wherein displaying the alternate reality content in the main view of the HMD and the PIP content in the PIP view of the HMD comprises displaying second virtual reality content in the PIP view.

In Example 89, the subject matter of Example 88 optionally includes wherein displaying the second virtual reality content in the PIP view comprises displaying virtual reality content of a teammate of the user in the PIP view.

In Example 90, the subject matter of any one or more of Examples 88-89 optionally include wherein displaying the second virtual reality content in the PIP view comprises displaying a preview of a different version of the virtual reality content in the PIP view.

Example 91 is at least one machine-readable medium including instructions, which when executed by a machine, cause the machine to perform operations of any of the operations of Examples 1-90.

Example 92 is an apparatus comprising means for performing any of the operations of Examples 1-90.

Example 93 is a system to perform the operations of any of the Examples 1-90.

Example 94 is a method to perform the operations of any of the Examples 1-90.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A head-mounted display system for presenting mixed reality presentations, the system comprising:
machine readable media including instructions; and
processing circuitry, configured by the instructions when in operation, to implement:
a context engine to determine a user context of a user of a head-mounted display (HMD);
a picture-in-picture (PIP) coordinator engine to determine a picture-in-picture (PIP) content for display in a PIP view of the HMD; and
a graphics driver to simultaneously display an alternate reality content in a main view of the HMD and the PIP content in the PIP view of the HMD.

2. The system of claim 1, wherein to determine the user context, the context engine is to interface with a sensor array of the HMD to determine a location of the user.

3. The system of claim 1, wherein to determine the user context, the context engine is to interface with a sensor array of the HMD to determine an activity of the user.

4. The system of claim 1, wherein to determine the user context, the context engine is to access user preferences, the user preferences to configure the display of the PIP content.

5. The system of claim 1, wherein to determine the PIP content for display in the PIP view of the HMD, the PIP coordinator is to access a rule database to select the PIP content from a plurality of PIP content based on the user context.

6. The system of claim 1, wherein to determine the PIP content for display in the PIP view of the HMD, the PIP coordinator is to:
receive an indication of a user input, the user input selecting the PIP view; and
swap the PIP content in PIP view with alternate reality content in the main view, placing the PIP content in the main view and the alternate reality content in the PIP view.

7. The system of claim 1, wherein to display the alternate reality content in the main view of the HMD and the PIP content in the PIP view of the HMD, the graphics driver is to display the PIP view as a floating window in the main view.

8. The system of claim 1, wherein the alternate reality content comprises virtual reality content, and wherein to display the alternate reality content in the main view of the HMD and the PIP content in the PIP view of the HMD, the graphics driver is to display second virtual reality content in the PIP view.

9. The system of claim 8, wherein to display the second virtual reality content in the PIP view, the graphics driver is to display virtual reality content of a teammate of the user in the PIP view.

10. The system of claim 8, wherein to display the second virtual reality content in the PIP view, the graphics driver is to display a preview of a different version of the virtual reality content in the PIP view.

11. A method of presenting mixed reality presentations, the method comprising:
determining a user context of a user of a head-mounted display (HMD);
determining a picture-in-picture (PIP) content for display in a PIP view of the HMD, and
displaying simultaneously an alternate reality content in a main view of the HMD and the PIP content in the PIP view of the HMD.

12. The method of claim 11, wherein the alternate reality content comprises virtual reality content, and wherein displaying the alternate reality content in the main view of the HMD and the PIP content in the PIP view of the HMD comprises displaying second virtual reality content in the PIP view.

13. The method of claim 11, wherein the alternate reality content comprises augmented reality content, and wherein displaying the alternate reality content in the main view of the HMD and the PIP content in the PIP view of the HMD comprises displaying virtual reality content in the PIP view.

14. At least one machine-readable medium including instructions for presenting mixed reality presentations, which when executed by a machine, cause the machine to perform the operations of:
determining a user context of a user of a head-mounted display (HMD);
determining a picture-in-picture (PIP) content for display in a PIP view of the HMD; and
displaying simultaneously an alternate reality content in a main view of the HMD and the PIP content in the PIP view of the HMD.

15. The at least one machine-readable medium of claim 14, wherein determining the PIP content for display in the PIP view of the HMD comprises accessing a rule database to select the PIP content from a plurality of PIP content based on the user context.

16. The at least one machine-readable medium of claim 14, wherein determining the PIP content for display in the PIP view of the HMD comprises:
receiving an indication of a user input, the user input selecting the PIP view; and
swapping the PIP content in PIP view with alternate reality content in the main view, placing the PIP content in the main view and the alternate reality content in the PIP view.

17. The at least one machine-readable medium of claim 14, wherein displaying the alternate reality content in the main view of the HMD and the PIP content in the PIP view of the HMD comprises displaying the PIP view as a floating window in the main view.

18. The at least one machine-readable medium of claim 14, wherein the alternate reality content comprises virtual reality content, and wherein displaying the alternate reality content in the main view of the HMD and the PIP content in the PIP view of the HMD comprises displaying second virtual reality content in the PIP view.

19. The at least one machine-readable medium of claim 18, wherein displaying the second virtual reality content in the PIP view comprises displaying virtual reality content of a teammate of the user in the PIP view.

20. The at least one machine-readable medium of claim 18, wherein displaying the second virtual reality content in the PIP view comprises displaying a preview of a different version of the virtual reality content in the PIP view.

21. The at least one machine-readable medium of claim 14, wherein the alternate reality content comprises augmented reality content, and wherein displaying the alternate reality content in the main view of the HMD and the PIP content in the PIP view of the HMD comprises displaying virtual reality content in the PIP view.

22. The at least one machine-readable medium of claim 21, wherein displaying virtual reality content in the PIP view comprises displaying virtual reality content of a teammate of the user in the PIP view.

23. The at least one machine-readable medium of claim 21, wherein displaying virtual reality content in the PIP view comprises displaying a preview of a different version of the augmented reality content in the PIP view.

24. The at least one machine-readable medium of claim 14, wherein the alternate reality content comprises virtual reality content, and wherein displaying the alternate reality content in the main view of the HMD and the PIP content in the PIP view of the HMD comprises displaying augmented reality content in the PIP view.

25. The at least one machine-readable medium of claim 24, wherein displaying augmented reality content in the PIP view comprises displaying augmented reality content of a teammate of the user in the PIP view.
